(19) United States
(12) Patent Application Publication
(10) Pub. No.: US 2004/0117841 A1
(43) Pub. Date: Jun. 17, 2004

(54) Digital broadcast reception apparatus

(76) Inventor: Akira Urakoshi, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/474,080

(22) PCT Filed: May 9, 2002
(86) PCT No.: PCT/JP02/04540

(30) Foreign Application Priority Data
May 16, 2001 (JP) 2001-146717

(51) Int. Cl. H04N 5/445; G06F 13/00; G06F 3/00; H04N 7/16; H04N 7/173

(52) U.S. Cl. 725/104; 725/60; 725/61; 725/87; 725/89; 725/8

(57) ABSTRACT

There is provided a digital broadcasting receiver capable of reducing the occurrence of situations where a charge for purchase is forced to be paid, although a purchased pay program cannot be viewed due to worsened weather, power failure, or the like. When a channel is turned in to a pay per view (PPV) program, a part of the program can be viewed free of charge in a preview period. When a user performs a purchase operation in an attempt to purchase the program, a digital broadcasting receiver 30 does not immediately perform purchase processing but waits until the preview period is almost terminated, and performs the purchase processing for an IC card 21A only when the receiving condition is within an allowable range at this time point. On the other hand, it does not perform purchase processing when the receiving condition is not within the allowable range.

### TECHNICAL FIELD

The present invention relates to a digital broadcasting receiver that receives and demodulates a digital broadcasting wave and outputs a video signal and an audio signal.

### BACKGROUND ART

In a digital broadcasting system using a satellite, for example, a video and audio signal is compressed using a digital signal compression technique, and a stream on which video and audio digital signals on a plurality of programs are time-division multiplexed (a transport stream) is broadcast via a transponder (a satellite relay). On the other hand, a broadcasting receiver for receiving such digital broadcasting selects by a tuner one of a plurality of transponders in digital broadcasting received through a dedicated antenna, selects by demultiplex processing one of a plurality of channels included in the one transponder, and decodes a digital signal on the selected channel, to output a video and audio signal.

In the above-mentioned digital broadcasting, PPV (Pay Per View) programs which can be purchased for each of the programs are broadcast, and a user can purchase and view the program which he or she desires to view by a remote control operation then and there. Further, a preview for informing a viewer what type of program is the PPV program is generally given for the purpose of urging the user to purchase the program. Within a period of the preview, when the PPV program is tuned in to, a part of the program can be viewed free of charge. Information related to the PPV program which is purchased by the user is generally transmitted to a charge information collection center through a telephone line on a predetermined date for each month, and a demand for payment corresponding to the amount of purchase is put to the user.

Meanwhile, a contract for purchase of the PPV program is concluded at the time point where a purchase operation is performed by a remote control. The user generally purchases the PPV program by a remote control operation during the preview period. Even if the PPV program cannot be viewed because the receiving condition is worsened by a sudden change in weather or cannot be viewed due to power failure, for example, after the purchase operation is performed, however, the user must pay the charge for purchase of the PPV program because the contract for purchase has already been concluded.

In view of the foregoing circumstances, an object of the present invention is to provide a digital broadcasting receiver capable of reducing the occurrence of situations where a charge for purchase is forced to be paid, although a purchased pay program cannot be viewed due to worsened weather, power failure, or the like.

### DISCLOSURE OF INVENTION

In order to solve the above-mentioned problem, in a digital broadcasting receiver that receives and demodulates a digital broadcasting wave and outputs a video signal and an audio signal, a digital broadcasting receiver according to the present invention is characterized by comprising means for individually purchasing a pay program on the basis of a user operation, to make it possible to view the pay program; timer means for judging, on the basis of information related to a charge-free viewing time period of the pay program, an elapse of the charge-free viewing time period; and control means for performing pay program purchase processing immediately before an elapse of the charge-free viewing time period when it receives an instruction to purchase the pay program by a user.

In the above-mentioned configuration, even if the power fails after the purchase operation of the pay program is performed by the user, if the power failure occurs during a charge-free viewing time period, situations where a charge for purchase is forced to be paid, although the purchased pay program cannot be viewed, are prevented because the pay program purchase processing has not been performed yet.

Furthermore, in a digital broadcasting receiver that receives and demodulates a digital broadcasting wave and outputs a video signal and an audio signal, a digital broadcasting receiver according to the present invention is characterized by comprising means for outputting information representing the receiving condition of the digital broadcasting wave; means for individually purchasing a pay program on the basis of a user operation, to make it possible to view the pay program; timer means for judging, on the basis of information related to a charge-free viewing time period of the pay program, an elapse of the charge-free viewing time period; and control means for performing pay program purchase processing under the condition that the receiving condition is in an allowable range immediately before an elapse of the charge-free viewing time period when it receives an instruction to purchase the pay program by a user.

In the above-mentioned configuration, even if the broadcasting cannot be viewed due to a sudden change in weather after the purchase operation of the pay program is performed by the user, if the sudden change in weather occurs during a charge-free viewing time period, situations where a charge for purchase is forced to be paid, although the purchased pay program cannot be viewed are prevented because the pay program purchase processing has not been performed yet.

When the pay program purchase processing is not performed, a message indicating that the pay program purchase processing is not performed may be displayed on a screen. Further, the digital broadcasting receiver is so constructed as to perform processing for inquiring the user whether or not the pay program will be purchased even in the condition of low hierarchical broadcasting and perform purchase/non-purchase processing, conforming to a command issued by the user, corresponding to the inquiry processing.

### BRIEF DESCRIPTION OF DRAWINGS

FIG. 1 is a block diagram showing a digital broadcasting receiver according to an embodiment of the present invention.

FIG. 2 is a flow chart showing an example of the contents of processing in the present invention.

FIG. 3 is an illustration showing a preview screen.

### BEST MODE FOR CARRYING OUT THE INVENTION

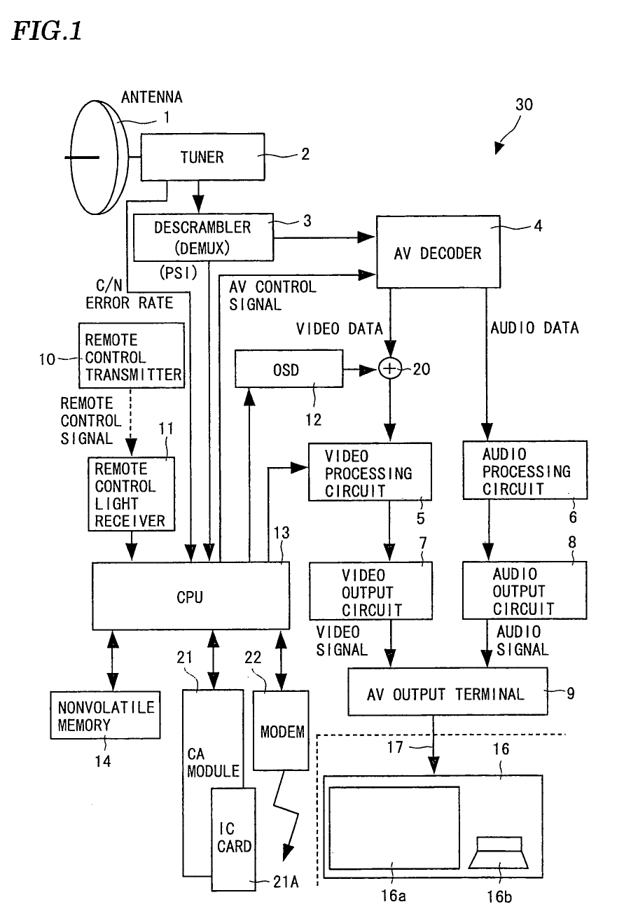

An embodiment of the present invention will be described on the basis of FIGS. 1 to 3. Here, a case where a user receives CS (Communication Satellite) digital broadcasting is exemplified.

FIG. 1 is a block diagram showing a digital broadcasting receiver 30 according to the present embodiment that receives CS digital broadcasting.

An antenna 1 is arranged in a predetermined direction outdoors, and receives a digital broadcasting signal sent from a CS. The antenna 1 generally comprises a frequency converter, and feeds to a tuner 2 a signal which has been subjected to receiving/frequency conversion.

The tuner 2 takes out a signal having a particular frequency out of high-frequency digital modulation signals including video and audio data. That is, it performs processing for selecting one of a plurality of transponders in digital broadcasting. Further, the tuner 2 comprises a demodulation circuit, an inverse interleave circuit, an error correcting circuit, and so forth, thereby to demodulate the selected digital modulation signal to output a transport stream. Further, the tuner 2 feeds to a CPU 13 an error rate obtained in error correction or a C/N ratio (they are information representing the receiving condition).

A descrambler 3 performs processing for releasing scrambling performed in pay broadcasting using key information incorporated in an IC card 21A. Further, the descrambler 3 has a demultiplexer (DEMUX), and separates the transport stream which has been subjected to descramble processing into a video stream and an audio stream based on MPEG2 (Moving Picture Experts Group 2), and PSI/SI (Program Specific Information/Service Information). The demultiplexer feeds the video stream and the audio stream to an AV decoder 4, and feeds the PSI/SI to the CPU 13. A plurality of channels are multiplexed on the transport stream, as described above. Processing for selecting any one of the channels can be performed by taking out of the PSI/SI data indicating which packet ID in the transport stream is used to multiplex the arbitrary channel. The selection of the transport stream (the selection of the transponder) can be made on the basis of information related to the PSI/SI. Further, SI (service information) includes program information (the contents of a program, the time when the program begins, a time period during which the program is continued, genre information, etc.).

The AV decoder 4 comprises a video decoder for decoding the video stream and an audio decoder for decoding the audio stream. The video decoder decodes an inputted variable length code to find a quantization factor and a motion vector, thereby to carry out inverse DCT (Discrete Cosine Transformation) and motion compensation control based on the motion vector. The audio decorder decodes a coded signal which has been inputted, to generate audio data. The video data produced by the decoding is outputted to a video processing circuit 5, and the audio data is outputted to an audio processing circuit 6.

The video processing circuit 5 receives the video data from the AV decoder 4 and subjects the received video data to D/A (Digital-to-Analog) conversion, to convert the video data to a composite video signal, for example. The audio signal processing circuit 6 receives the audio data outputted from the AV decoder 4 and subjects the received audio data to D/A conversion, to generate an analog signal of a right (R) sound and an analog signal of a left (L) sound.

A video output circuit 7 and an audio output circuit 8 are constructed by comprising an output resistor, an amplifier, and so forth. An AV output terminal 9 is provided with an output unit (a set of a right/left audio output terminal or the like and a video output terminal or the like). A monitor 16 comprising a CRT (Cathode-Ray Tube) 16a and a speaker 16b is connected to the output unit by a video and audio code 17.

An OSD (On-screen Display) circuit 12 produces video data based on character information and color information which are instructed to output from the CPU 13, and outputs the produced video data to an adder 20. The adder 20 performs processing for incorporating the video data into the received video data outputted from the AV decoder 4.

A remote control transmitter 10 is a transmitter for sending out a command to a corresponding broadcasting receiver 30. When a key (not shown) provided in the remote control transmitter 10 is operated, signal light (a remote control signal) meaning a command corresponding to the key is sent out from a light emitter (not shown). A remote control light receiver 11 receives the signal light, converts the signal light into an electric signal, and feeds the electric signal to the CPU 13.

A nonvolatile memory (e.g., an EEPROM (Electrically Erasable and Programmable ROM)) 14 stores program information (the time when a program begins, a time period during which the program is continued, a channel number, etc.), information set by the user, and so forth.

The IC card 21A stores key information for making it possible to view paid broadcasting and purchase historical information related to PPV (Pay Per View) programs for which the user is to be charged for each of the programs. A CA module 21 performs write processing and readout processing of the information between the CPU 13 and the IC card 21A. The information include preview information (information related to a preview period and information related to a period during which purchase is possible) making it possible to view the pay program which has not been purchased yet only for a predetermined time period (time) in addition to key information, which is required to view the paid digital broadcasting, a purchase command, and purchase historical information. The CPU 13 can judge how long the pay program selected by the user is continued until the preview is terminated by the information related to a preview period and information related to an elapsed time from a timer (not shown).

A modem 22 is operated under the control of the CPU 13 in dial-up connection in cases such as a case where charge information is periodically transmitted.

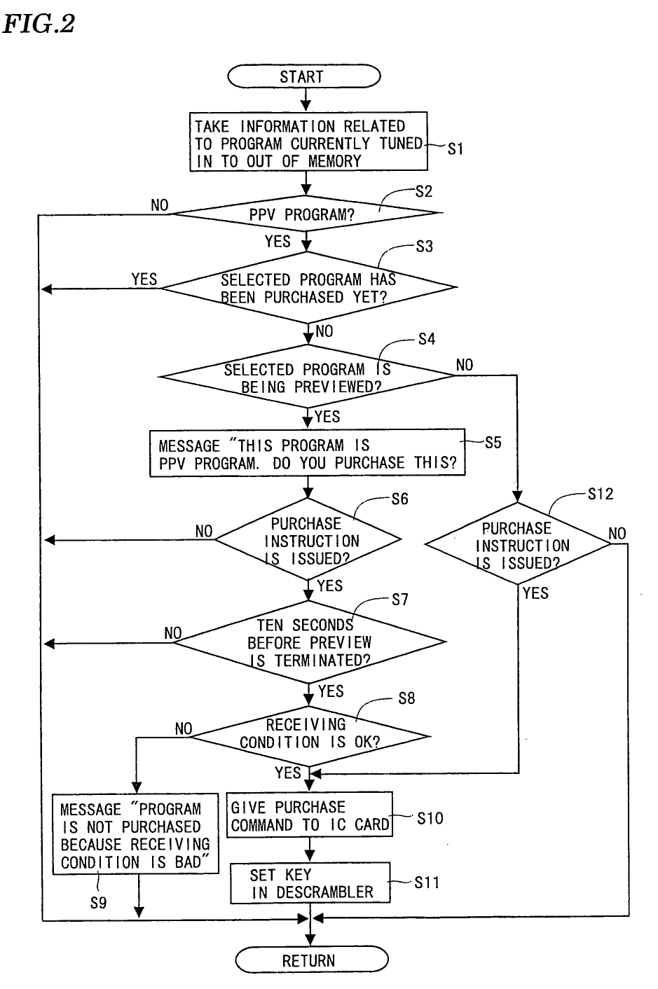

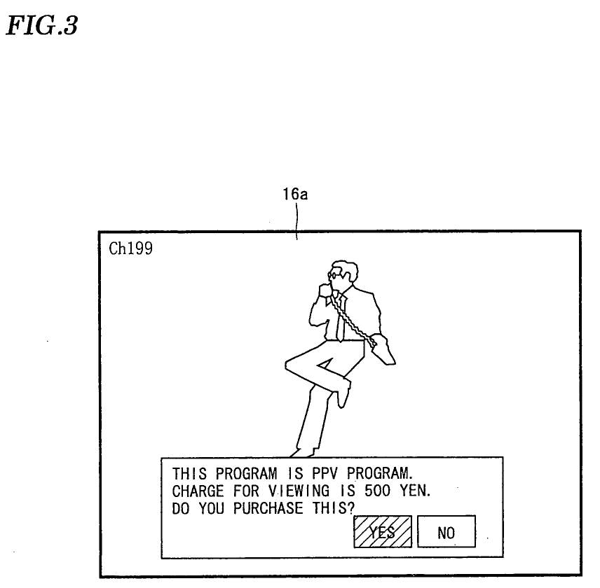

The CPU 13 performs processing such as channel selection by the user using the remote control transmitter 10 or the like. As the processing according to the present invention, processing related to the purchase of the PPV program is performed. The contents of the processing will be described on the basis of a flow chart shown in FIG. 2. First, program-related information related to a program which is currently tuned in to is taken out of the memory 14 (step S), it is judged whether or not the program is a PPV program (step S2), it is judged whether or not the program has already been purchased if the program is a PPV program (step S3), and it is judged whether or not the program is being previewed if the program has not been purchased yet (step S4). When the preview is terminated, a purchase operation is immediately performed if an instruction to purchase the program is issued (steps S12, S10, and S11). On the other hand, if the program is being previewed, a predetermined message (see FIG. 3), together with received video, is displayed (step S5), and it is judged whether or not the instruction to purchase the program is issued (step S6). In this case, the purchase operation is not immediately performed even if the instruction to purchase the program is issued, but is waited for immediately before the preview is terminated (step S7). Immediately before the preview is terminated, it is judged whether or not the receiving condition is within an allowable range (step S8). The judgment is made on the basis of the C/N rate and the error rate which are outputted from the tuner 2. Unless the receiving condition is within the allowable range, the purchase operation is not performed, to display a message saying “the program is not purchased because the receiving condition is bad” (step S9). On the other hand, if the receiving condition is within the allowable range, the purchase operation is performed (step S10, step S11).

Although in the foregoing description, a case where CS digital broadcasting is received is exemplified, the present invention is also applicable to a case where a PPV program is broadcast in BS digital broadcasting. In BS digital broadcasting, rainfall correspondence broadcasting using hierarchical modulation can be performed. In view of such a case, however, it is desirable to cause the user to previously determine whether or not a program is purchased even in the condition of low hierarchical broadcasting. For example, a purchase determination menu is prepared on a menu screen, the user is caused to previously determine whether or not a program is purchased by a remote control operation, and the receiver performs purchase/non-purchase processing in accordance with the determination.

As described in the foregoing, according to the present invention, even if the broadcasting cannot be viewed due to power failure or a sudden change in weather after a purchase operation of a pay program is performed by a user, if this phenomenon arises during a charge-free viewing time period, the effect of preventing situations where a charge for purchase is forced to be paid even though the purchased pay program cannot be viewed is produced because pay program purchase processing has not been performed yet.

1. In a digital broadcasting receiver that receives and demodulates a digital broadcasting wave and outputs a video signal and an audio signal,
a digital broadcasting receiver characterized by comprising:
means for individually purchasing a pay program on the basis of a user operation, to make it possible to view the pay program;
timer means for judging, on the basis of information related to a charge-free viewing time period of the pay program, an elapse of the charge-free viewing time period; and
control means for performing pay program purchase processing immediately before an elapse of said charge-free viewing time period when it receives an instruction to purchase the pay program by a user.

2. In a digital broadcasting receiver that receives and demodulates a digital broadcasting wave and outputs a video signal and an audio signal,
a digital broadcasting receiver characterized by comprising:
means for outputting information representing the receiving condition of the digital broadcasting wave;
means for individually purchasing a pay program on the basis of a user operation, to make it possible to view the pay program;
timer means for judging, on the basis of information related to a charge-free viewing time period of the pay program, an elapse of the charge-free viewing time period; and
control means for performing pay program purchase processing under the condition that said receiving condition is in an allowable range immediately before an elapse of said charge-free viewing time period when it receives an instruction to purchase the pay program by a user.

3. The digital broadcasting receiver according to claim 1 or 2, characterized by being so constructed as to display, when the pay program purchase processing is not performed, a message saying that the pay program purchase processing is not performed on a screen.

4. The digital broadcasting receiver according to any one of claims 1 to 3, characterized by being so constructed as to perform processing for inquiring the user whether or not the pay program will be purchased even in the condition of low hierarchical broadcasting and perform purchase/non-purchase processing, conforming to a command issued by the user, corresponding to the inquiry processing.
